(19) United States
(12) Patent Application Publication
(10) Pub. No.: US 2019/0366803 A1
(43) Pub. Date: Dec. 5, 2019

(54) CONDITIONED AIR SYSTEM WITH MOTOR AND TURBINE

(71) Applicant: Mark Harris Engineering LLC, South Kingstown, RI (US)

(72) Inventor: Mark Harris, South Kingstown, RI (US)

(73) Assignee: Mark Harris Engineering LLC, South Kingstown, RI (US)

(21) Appl. No.: 16/429,412

(22) Filed: Jun. 3, 2019

Related U.S. Application Data
(60) Provisional application No. 62/680,319, filed on Jun. 4, 2018.

(51) Int. Cl. B60H 1/14; F24F 3/153; B60H 1/00

(52) U.S. Cl. CPC B60H 1/14; B60H 1/00321; F24F 3/153

(57) ABSTRACT

An air conditioning system includes a shaft rotated by a motor during operation. A compressor having a compressor wheel, an intake port to receive a gas from an external source, and an output port to provide the gas in a compressed state, is connected to the shaft. A turbine including a turbine wheel, an intake port to receive compressed gas, and an output port to provide the gas in an expanded state, is also connected to the shaft. Energy from expansion of the gas from the turbine drives the rotating shaft, and the rotating shaft turn the compressor wheel in order to compress the gas, which exits through the output port.

### RELATED APPLICATIONS

This patent claims priority to and benefit of U.S. Provisional Patent Application No. 62/680,319 (filed Jun. 4, 2018). All documents cited in this section are incorporated here by reference in their entirety.

### FIELD

This patent is related generally to heating and air conditioning and, more specifically, to an electric conditioned air system for vehicles and structures with improved efficiency.

### BACKGROUND

The current art of air conditioning for small fixed wing and rotary wing aircraft as well as automotive and industrial applications utilize various configurations of vapor cycle system technology like those commonly used in domestic and commercial cooling systems. These systems provide only cooling and de-humidification and rely on chlorofluorocarbon (“CFC”) type refrigerants for operation. Heating is typically provided either by engine waste or by simple resistive electric heat. These vapor cycle systems do not provide air for cabin pressurization.

Larger aircraft air conditioning is typically provided by some configuration of air cycle system which is powered by high pressure bleed air from the gas turbine engines. Extracting bleed air from the gas turbine engines significantly reduces fuel economy. These types of systems provide both heating and cooling and use only air as their working fluid. These systems provide conditioned air for cabin compartment pressurization and many provide enhanced de-humidification utilizing high pressure water extraction systems.

### SUMMARY

One object of the disclosed technology is to provide and control conditioned air to an enclosed space which requires heating, cooling, humidity reduction, air circulation and/or temperature regulation with only electrical energy provided by either batteries or generators, and without the use of a compressed air source such as a gas turbine engine.

In an embodiment, a method and apparatus for providing conditioned air without the use of environmentally harmful liquids or vapors through the novel use of electric motor driven Turboexpander technology utilizing air as the working fluid. A Turboexpander in this context is also known as a bootstrap air cycle machine: a rotating machine that comprises a compressor wheel and expansion turbine on the same shaft such that the power extracted by the expansion turbine is directly applied to the compressor through the common shaft. In some instances, the power produced by the expansion turbine may be less than the total amount required for the complete rotating assembly due to mechanical losses, wheel efficiencies and turbine temperature. Thus, an electric motor may be included to apply power to the shaft and assist in driving the compressor to the desired speed.

The described systems provide environmentally friendly, efficient, light weight air conditioning for air and ground transportation vehicles, as well as other applications. A high-speed BLDC motor-driven bootstrap air cycle machine may be employed for the compression and expansion of the conditioned air within the operational reverse Brayton refrigeration cycle. A primary heat exchanger may cool the compressed air using outside ambient air and may utilize a high-pressure water separation system to condense, extract and reheat the entrained moisture within the conditioned air. The conditioned air temperature and flow can be controlled through modulation of the primary heat exchanger cooling air flow, modulation of a bootstrap bypass valve, and motor speed. The compartment temperature can be controlled through modulation of the temperature of the air exiting the air condition system. The conditioned air supplied to the compartment may be well below humidity saturation due to the high-pressure water extraction system, which provides better dehydration than a vapor cycle system that simply condenses the entrained water vapor at atmospheric pressure.

The high-pressure water extraction system may include a condenser heat exchanger, a reheat heat exchanger, and a water separator in a series combination. The conditioned air from the primary heat exchanger enters the reheat heat exchanger then enters the condenser heat exchanger prior to the water extractor. The water collected by the extractor is piped to the face of the primary heat exchanger and sprayed onto the inlet face to increase heat exchanger effectiveness by up to about 5% or more. The conditioned air may then enter the cold side of the Reheat heat exchanger where any entrained moisture is re-evaporated prior to entry into the expansion turbine. The cooled and conditioned air exiting the expansion turbine then passes through the cold side of the condenser prior to exhausting to the compartment.

The temperature and flow rate of conditioned air supplied to the compartment can be controlled to ensure that the required amount of fresh air, per cooling demand or specific regulation, is supplied to the compartment and that the temperature of the conditioned air falls within specific limits as needed to maintain the compartment at a selectable temperature.

### BRIEF DESCRIPTION OF THE DRAWINGS

The foregoing features may be more fully understood from the following description of the drawings. The drawings aid in explaining and understanding the disclosed technology. Since it is often impractical or impossible to illustrate and describe every possible embodiment, the provided figures depict one or more exemplary embodiments. Accordingly, the figures are not intended to limit the scope of the invention. Like numbers in the figures denote like elements.

FIG. 1 is a block diagram of an air conditioning system for heating and cooling.

FIG. 2 is a cross-sectional view of a shaft with compressor, motor, and turbine.

FIG. 3 is a cross-sectional view of a shaft, generator, and turbine.

### DETAILED DESCRIPTION

For illustrative purposes, the air cycle machine described for use in air vehicles, such as airplanes, jets, helicopters, VTOL aircraft, air taxis, and other applications. However, it is to be understood that the air cycle machine may be adapted for use in ground vehicles, sea vehicles and structures on land and sea. Although the air cycle machine was intended to provide conditioned air for the comfort of passengers and occupants, it is to be understood that the air cycle machine may be used to provide conditioned air for other purposes such as conditioned air for equipment, stored goods and perishables, or other cargo, as desired.

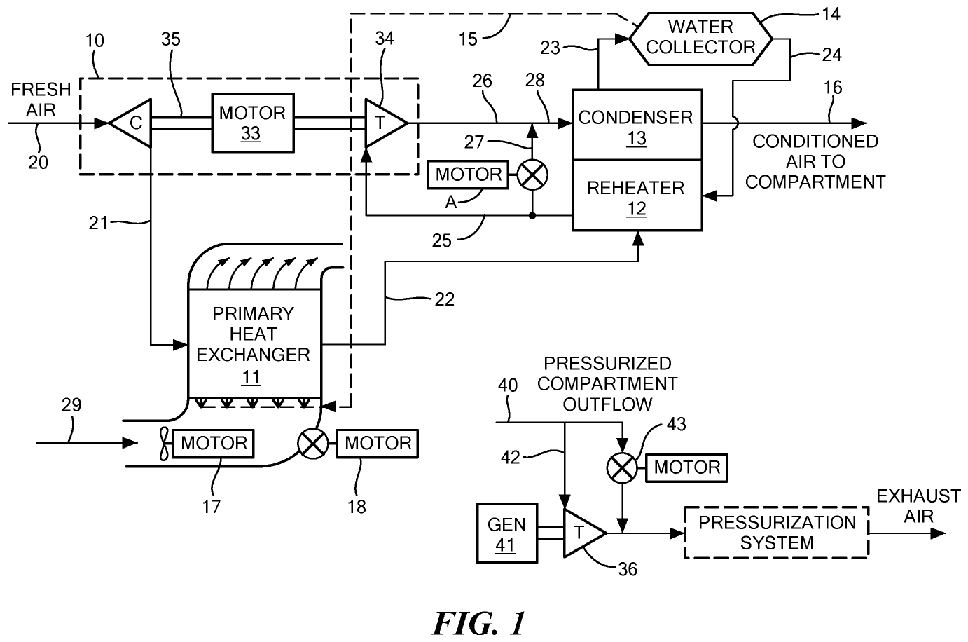

Referring now to FIG. 1, air cycle machine 10 includes a compressor 32, motor 33, and turbine 34, which may all be operatively coupled to a common shaft 35. Outside or ambient air 20 is drawn into the compressor 32 of air cycle machine 10 and the pressure and temperature of the inlet air is increased. The compressed air 21 then exits the compressor and passes through the primary heat exchanger 11 where it is cooled by exchanging heat energy with outside or ambient air that passes through the cold side of the heat exchanger 11. The compressed air 22, which is at a reduced temperature, exits primary heat exchanger 11 and enters the warm side inlet of the reheat heat exchanger 12 where it is cooled by air path 24 from the Water Separator 14.

The air then flows through the condenser 13 where it is cooled by mixed turbine outlet air 28 and the water vapor is condensed out of the air. The cooled air 23 with entrained water then passes through the water separator 14 where high-pressure liquid water is separated from the air 23. The liquid water is then transported by line 15 back to the primary heat exchanger where it is sprayed on the inlet face to increase heat exchanger performance.

The air 14 exiting the water separator then enters the cold side of a reheat heat exchanger 12 where any entrained water is again evaporated and the air is warmed up prior to entering the expansion turbine 34. The air 25 received by turbine 34 expands and drives turbine 34, which in turn drives shaft 35. Reheating the air prior to it arriving at turbine 34 ensures that no free water enters the expansion turbine, thus preventing the potential for ice forming during the expansion process.

The turbine exhaust air 26 is mixed with turbine bypass air 27 which is regulated by turbine bypass valve 19 to control the temperature of the air 28 entering the condenser 13. The conditioned air 16 exits the condenser 13 and is ducted to the compartment where it provides the amount of fresh air, heating, and cooling required to maintain the compartment temperature at the desired temperature and, for pressurized compartment applications, provides the pressurized air required for compartment pressurization control.

The motor-driven Turbo-compressor air cycle machine may comprise a centrifugal compressor section 32, a centrifugal turbine 34, and a motor 33 all attached to and rotating on the same shaft 35. Motor 33 may be an electric motor such as a BLDC motor, an AC brushless motor, a direct drive motor, etc. In other embodiments, motor 33 may be a compound motor, a gas motor, or any type of motor that can drive shaft 35.

Motor 33 and turbine 34 may apply power to the rotating assembly and compressor 32 extracts power from the assembly to compress air 21. The speed of the rotating assembly and compressor geometry may determine the pressure rise of the compressor. The power applied to the rotating assembly may be a function of the pressure ratio across the turbine and the flow of air 25 through the turbine, which it turn may be a function of the flow through the compressor 32 and the amount of turbine bypass air 27 allowed by the turbine bypass valve 19. Thus, the amount of power required by motor 33 may be the difference between the power required to compress air 21 and the power recovered from air 25 by turbine 34. For example, if the system flow were 30 lbs/min and the compressor ratio was 2:1 (14.7 psia to 29.4 psia), the compressor would require around 30 HP to operate. At this condition, the expansion turbine could produce around 17 HP for the rotating assembly. Therefore, motor 33 would only be required to produce 13 HP to turn shaft 35 and operate the system at the desired condition.

Placing motor 33 on the same rotating assembly as the so-called “boot-strap” Turbo-compressor 34 reduces the number of system components required, simplifies the system architecture, increases system reliability, and increases the controllability of the overall air cycle system.

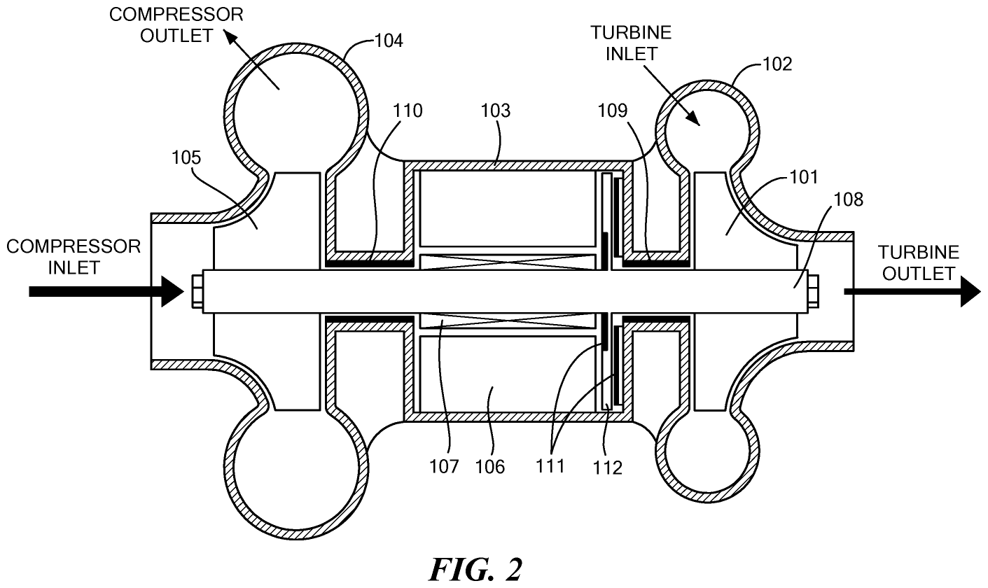

FIG. 2 shows a simplified cutaway of one configuration of the Air cycle machine 10 which is comprised of an expansion turbine 101, which may be the same as or similar to turbine 34, contained in a turbine housing 102 and a centrifugal compressor 105, which may be the same as or similar to compressor 32, contained in a compressor housing 104. In this example, motor 34 may be a BLDC motor having rotor magnets 107. Shaft 108 may be the same as or similar to shaft 35.

Both compressor 105 and turbine 101 wheels and the rotor magnets 107 may be mounted on the same shaft 108. The motor's stator 106 may be contained within the motor housing 103. The shaft 108 can be supported by two hydro-dynamic air bearings 109 and 110 and a hybrid magnetic/hydro-dynamic thrust bearing system 111.

The Primary Heat Exchanger 11 cools the compressed air 21 using outside ambient air 29 that is drawn into the heat exchanger by a motor-driven fan 17 when on the ground and in low speed flight. At higher flight speeds, ambient air is driven into and through the primary heat exchanger through the ram effect of the forward motion of the vehicle and the motor-driven fan 17 may transition to an electrical generation mode of operation which acts to add electrical power to the motor-driven air cycle system to decrease the amount of power required from the vehicle batteries or electrical generator system. The amount of primary heat exchanger cooling provided can be determined by either the speed of the motor-driven fan 17 while on the ground or at low vehicle speed or, when at higher vehicle speeds, by modulation of a Heat Exchanger Bypass Valve 18 which allows some ambient air entering the heat exchanger inlet duct to simply bypass the heat exchanger and exit the rear of the inlet duct.

For air vehicles that operate at altitudes requiring compartment pressurization, an embodiment of the current invention includes a turbo-generator 41 which utilizes the compartment exhaust air 40 to provide electrical power for the motor-driven air cycle machine 10. This may significantly reduce the power required from the air vehicle batteries or electrical generation system. Pressurized compartment air 40 may be directed to either the inlet of an expansion turbine 44 connected to an electric generator 41 where the air 42 may be expanded to near outside ambient pressure and ported to the compartment pressurization system. Additionally, or alternatively, the air may be ported to turbine bypass valve 43, which may divert a portion of the cabin exhaust air around the turbine and delivers it to the compartment pressurization system. The mechanical energy extracted by the expansion turbine 44 rotates the generator 41 to create electrical energy which is then used by the system for significant power reduction. The portion of air bypassed around the turbine may be regulated by the turbine bypass valve 43 to maintain optimal generator speeds and to limit the temperature of the air routed to the pressurization system.

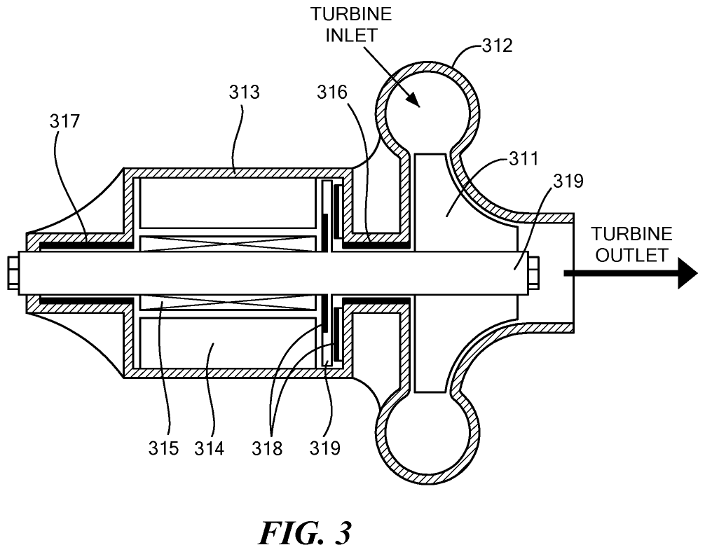

FIG. 3 shows a simplified cutaway of the Turbo-Generator 41 which is comprised of a turbine wheel 311 contained in a turbine housing 312. The turbine wheel 311 and Generator rotor magnets 315 are connected to the rotating assembly shaft 319. The Generator stator assembly 314 is mounted within a generator housing 313. In an embodiment, the rotating assembly is supported by two hydro-dynamic air bearings 316 and 317 and a hybrid magnetic/hydrodynamic thrust bearing system 318.

In embodiments, the bearing configuration is the same as or similar to that of the motor-driven turbo-compressor of FIG. 2. For example, the bearing configuration may include two hydrodynamic air journal bearings 316 and 317 located between the generator and the turbine and the opposite side of the generator respectively for support of the rotating assembly. The hydro-dynamic air bearings may provide a near frictionless interface between the housing and the rotating shaft 319 while providing balanced radial support to the rotating assembly. The axial forces of the rotating assembly may be additionally supported by hybrid magnetic-hydrodynamic thrust bearings 318, which may limit axial motion of the rotating assembly to within allowable tolerances when axial forces vary during system operating conditions. The use of a hybrid combination of a magnetic bearing on the generator side of the thrust runner 319 and a hydro-dynamic air bearing on the other side of the thrust runner may provide consistent loading on the air bearing during variations in axial loading on the rotating assembly.

Those skilled in the art will appreciate that the conception, upon which this disclosure is based, may readily be utilized as a basis for designing other products without departing from the spirit and scope of the invention as defined by the appended claims. Therefore, the claims are not to be limited to the specific examples depicted herein. For example, the features of one example disclosed above can be used with the features of another example. Furthermore, various modifications and rearrangements of the parts may be made without departing from the spirit and scope of the underlying inventive concept. For example, the geometric configurations disclosed herein may be altered depending upon the application, as may the material selection for the components. Thus, the details of these components as set forth in the above-described examples, should not limit the scope of the claims.

Having described preferred embodiments, which serve to illustrate various concepts, structures and techniques, which are the subject of this patent, it will now become apparent to those of ordinary skill in the art that other embodiments incorporating these concepts, structures and techniques may be used. Accordingly, it is submitted that that scope of the patent should not be limited to the described embodiments but rather should be limited only by the spirit and scope of the following claims. All references cited herein are hereby incorporated herein by reference in their entirety.

1. An air conditioning system comprising:
a shaft rotated by a motor during operation;
a compressor including having a compressor wheel, an intake port to receive a gas from an external source, and an output port to provide the gas in a compressed state, the compressor operatively connected to the shaft;
a turbine including a turbine wheel, an intake port to receive compressed gas, and an output port to provide the gas in an expanded state, the turbine operatively connected to the shaft; and
wherein energy from expansion of the gas from the turbine drives the rotating shaft, and the rotating shaft turn the compressor wheel in order to compress the gas, which exits through the output port.

2. The air conditioning system of claim 1 wherein the compressor wheel is coupled to a proximal end of the rotating shaft and the turbine is coupled to an opposing, distal end of the rotating shaft.

3. The air conditioning system of claim 1 wherein the motor is situated between the compressor wheel and the turbine wheel.

4. The air conditioning system of claim 1 further comprising a first heat exchanger coupled to receive compressed gas from the output port of the compressor and cool the compressed gas by transferring heat from the compressed gas to outside, ambient air.

5. The air conditioning system of claim 4 further comprising a reheat heat exchanger, wherein the output of the first heat exchanger provides cooled and compressed gas to an input of the reheat heat exchange, and wherein the reheat heat exchanger further cools the cooled and compressed gas.

6. The air conditioning system of claim 5 further comprising a condenser coupled to receive gas from the reheat heat exchanger and the output port of the turbine, wherein the condenser is configured to use the gas from the output port of the turbine to further cool and remove moisture from the gas from the reheat heat exchanger.

7. The air conditioning system of claim 6 further comprising a water separator coupled to receive gas from the condenser and provide liquid water to the reheat heat exchanger for evaporation and subsequent delivery to the intake of the turbine.

8. The air conditioning system of claim 5 further comprising a second turbine having an intake to receive pressurized air from a pressurized cabin, wherein the second turbine is coupled to an electrical generator that produces electrical power.

9. The air conditioning system of claim 1 wherein the air conditioning system is an air conditioning system for a vehicle.

10. The cooling and heating system of claim 9 wherein the vehicle is chosen from the list consisting of: an airplane, a car, a truck, a train, a subway, a vehicle with a pressurized cabin, a vehicle with an unpressurized cabin, and a vehicle with a closed cabin.

11. The air conditioning system of claim 1 wherein the motor is an electric motor.

12. The air conditioning system of claim 1 wherein the air conditioning system is a cooling and/or heating system.

13. The air conditioning system of claim 1 wherein the shaft is supported by one or more air bearings, one or more magnetic bearings, or a combination of one or more air bearings and one or more magnetic bearings.

14. A method of heating or cooling gas comprising:
rotating a shaft with a motor;
compressing gas by a compressor that is operatively connected to the shaft to produce the gas in a compressed state;
cooling the compressed gas;
expanding the compressed and cooled gas by a turbine that is operatively connected to the shaft; and
wherein energy from expansion of the gas from the turbine rotates the shaft, which turns the compressor to produce the gas in the compressed state.

15. The method of claim 14 further comprising cooling the compressed gas with a first heat exchanger that transfers heat from the compressed gas to outside, ambient air.

16. The method of claim 15 further comprising cooling the compressed gas with a second heat exchanger.

17. The method of claim 15 further comprising:
reducing the chance of ice formation during expansion by the turbine by:
separating water from the compressed gas to produce a stream of liquid water;
routing the liquid water away from the compressed gas;
spraying the liquid water on a face of the first heat exchanger, and
re-evaporating any liquid water remaining in the compressed gas to reduce an amount of water entering an input of the turbine.

18. The method of claim 13 further comprising generating electrical energy with a second turbine, wherein the second turbine is powered by an air outflow from a pressurized passenger cabin.

19. The method of claim 18 further comprising using the electrical energy to provide power to an electrical system or the motor.
